(19) United States
(12) Patent Application Publication
(10) Pub. No.: US 2026/0071490 A1
(43) Pub. Date: Mar. 12, 2026

(54) ANGLED PET GATE ASSEMBLY

(71) Applicant: Diggs Inc., New York, NY (US)

(72) Inventors: Isaac Haverlick, Jersey City, NJ (US); Gregory Hoge, Ridgewood, NY (US); Zel Crampton, Brooklyn, NY (US); Courtney Armstrong, Astoria, NY (US); Lilly Althauser-Benson, Brandon, FL (US)

(21) Appl. No.: 19/324,759

(22) Filed: Sep. 10, 2025

Related U.S. Application Data
(60) Provisional application No. 63/693,043, filed on Sep. 10, 2024.

(51) Int. Cl. E06B 11/02; E05B 1/00; E05B 65/00; E06B 9/00

(52) U.S. Cl. CPC E06B 11/027; E05B 1/0038; E05B 65/0007; E06B 2009/002

(57) ABSTRACT

An animal gate used to block throughways may include a gate assembly which may include a first gate portion that may have a first frame and a second frame. The gate assembly may be positionable within an opening of a structure and couplable to the structure. The gate assembly may include a second gate portion pivotally coupled to the first frame such that the second gate portion may be pivotable about a horizontal axis between a first position and a second position. The gate assembly may include a locking mechanism arranged at least partly within the second gate portion and configured to lock the second gate portion in at least the first position such that in the first position the second gate portion may be arranged at an angle less than 90 degrees above horizontal. In some examples, pivoting the second gate portion to the second position permits the first frame and the second gate portion to pivot.

### REFERENCE TO RELATED APPLICATION

This application claims priority under 35 U.S.C § 119 to U.S. Provisional Ser. No. 63/693,043 filed on Sep. 10, 2024, the entire content and disclosure of which are incorporated herein by reference.

### TECHNICAL FIELD

The field of this technology relates to the pet industry, and, more particularly, to pet gates.

### BACKGROUND

Conventionally, pet gates are used to partition rooms of a home that a pet or animal would otherwise access. The pet gates may be attached to door jambs using hardware such as nails and screws and may damage the door jambs. In addition, most pet gates are short, flat, and provide minimal ability to reduce the likelihood of a pet jumping over and/or otherwise climbing over the pet gate. In addition, conventional pet gates often do not permit pet owners from easily changing rooms without having to unsafely step over the pet gate. Those pet gates that do offer doors are often complex and clumsy and wear down over time and do not reduce the likelihood of the pets jumping and/or climbing over the gate.

### SUMMARY

According to certain aspects, a pet gate assembly is discussed herein which may include an angled guard to help mitigate and/or prevent pets from leaning on the pet gate assembly or jumping over the pet gate assembly all together.

According to certain aspects, an animal gate used to block throughways may include a gate assembly which may include a first gate portion that may have a first frame and a second frame. The first gate portion may be positionable within an opening of a structure and couplable to the structure. The assembly may include a second gate portion pivotally coupled to the first frame such that the second gate portion may be pivotable about a horizontal axis between a first position and a second position. The assembly may include a locking mechanism arranged at least partly within the second gate portion and configured to lock the second gate portion in at least the first position such that in the first position the second gate portion may be arranged at an angle less than ninety degrees above horizontal. In some examples, pivoting the second gate portion to the second position permits the first frame and the second gate portion to pivot.

According to various embodiments, the angle may be between twenty-five degrees and sixty-five degrees above horizontal.

According to various embodiments, the first gate portion and the second gate portion may include an upper horizontal cross member, a lower horizontal cross member, and a plurality of vertical members extending between the upper horizontal cross member and the lower horizontal cross member, with a space between each vertical member of the plurality of vertical members being three inches or less.

According to various embodiments, the locking mechanism may include a button and the locking mechanism may be releasable by compressing the button.

According to various embodiments, the locking mechanism may include a locked state and an unlocked state, and in the unlocked state the second gate portion may be pivotable between the first position and the second position.

According to various embodiments, the gate assembly may include a width extender couplable to the second frame and positionable between the second frame and the structure. In some examples, the gate assembly may include a first angle guard coupled to the width extender and positioned at the same angle as the second gate portion in the first position.

According to various embodiments, the gate assembly may include an additional width extender couplable to the width extender.

According to various embodiments, the gate assembly may include a first angle guard coupled to the second frame, which may be arranged on a first side of the second gate portion, and may be positioned at the same angle as the second gate portion in the first position.

According to various embodiments, a gate assembly may include a first gate portion which may include a first frame and a second frame such that the first gate portion may be positionable within an opening of a structure and couplable to the structure. In some examples, the gate assembly may include a second gate portion extending from the first frame, such that the second gate portion is arranged at an angle less than ninety degrees above horizontal.

According to various embodiments, the first gate portion and the second gate portion each may include an upper horizontal cross member, a lower horizontal cross member, and a plurality of vertical members which may extend between the upper horizontal cross member and the lower horizontal cross member, such that a space between each vertical member of the plurality of vertical members may be three inches or less.

According to various embodiments, the second gate portion may be pivotally coupled to the first frame and the second gate portion may be pivotable about a horizontal axis between a first position and a second position.

According to various embodiments, the second gate portion may include a locking mechanism that may include a locked state and an unlocked state, and, in the locked state, the second gate portion may not be pivotable between the first position and the second position.

According to various embodiments, a tension adjuster may include a wheel mechanism disposed on a corner of the second frame such that adjusting the wheel mechanism may moves the tension adjuster along a horizontal direction.

According to various embodiments, the wheel mechanism may be covered on at least a first side of the second frame.

According to various embodiments, a method for operating a gate assembly may include a first gate portion and a second gate portion. In some examples, the first gate portion may include a first frame and a second frame and the second gate portion may be pivotally coupled to the first frame and may include a locking mechanism. In some examples, the method may include engaging the locking mechanism to change a lock state of the locking mechanism from a locked state to an unlocked state and may include pivoting the second gate portion about a horizontal axis from a first position to a second position and pivoting the first frame and the second gate portion about a vertical axis to open a gate opening in the second frame.

According to various embodiments, in the first position the second gate portion may be arranged at an angle less than 90 degrees above horizontal.

According to various embodiments, the angle may be between twenty-five degrees and sixty-five degrees above horizontal.

According to various embodiments, pivoting the second gate portion about a horizontal axis from the first position to the second position may enable pivoting the first frame and the second gate portion about a vertical axis to open a gate opening in the second frame.

According to various embodiments, the locking mechanism may include a button and engaging the locking mechanism may include compressing the button.

According to various embodiments, the method may include pivoting the first frame and the second gate portion about the vertical axis which may close the gate opening and may include pivoting the second gate portion about the horizontal axis from the second position to the first position.

Various implementations described herein may include additional devices, systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 is an example of a gate assembly, according to various embodiments.

FIG. 2 is an example installation of a gate assembly, according to various embodiments.

FIG. 3 is an example operation of a gate assembly, according to some embodiments.

FIG. 4 is an example front view of a gate assembly, according to some embodiments.

FIG. 5 is an example top view of a gate assembly, according to some embodiments.

FIG. 6 is an example bottom view of a gate assembly, according to some embodiments.

FIG. 7 is an example button locking mechanism of a gate assembly, according to some embodiments.

FIG. 8 is an example rotation mechanism side view of a rotation operation of a gate assembly, according to some embodiments.

FIG. 9 is an example of an operation to connect an angle guard of a gate assembly, according to some embodiments.

FIG. 10 is an example operation for connecting an additional width extender of a gate assembly, according to some embodiments.

FIG. 11 is an example operation for attaching a tension adjuster to a gate assembly, according to some embodiments.

FIG. 12 is an example operation of installing a tension adjuster of a gate assembly, according to some embodiments.

FIG. 13 is an example of a gate assembly, according to some embodiments.

FIG. 14 is an example rotation operation of a gate assembly, according to some embodiments.

FIG. 15 is an example method for a gate assembly, according to some embodiments.

In the drawings, like reference numerals refer to like parts throughout the various views unless otherwise specified. Not all instances of an element are necessarily labeled to improve clarity in the drawings where appropriate. The drawings are not necessarily to scale, emphasis instead being placed upon illustrating the principles being described.

### DETAILED DESCRIPTION

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As used herein, directional and spatial terms such as “horizontal,” “vertical,” “horizontally,” “vertically,” and “upward” are not intended to be limiting terms and are intended to indicate relative directions to a reference plane and/or surface.

The described embodiments provide a gate assembly. While the gate assembly is discussed for use with limiting access of pets of pet owners, they are by no means so limited. Rather, embodiments of the gate assembly may be used in conjunction with partitioning areas of any type or otherwise as desired.

Conventionally, pet gates are used to partition rooms of a home that a pet or animal would otherwise access. Owners of pets may use the pet gates to limit access for their pets for various reasons. For example, it is common for an individual to cook food in a kitchen of their home. Dogs have a sense of smell several times greater than that of humans and will often instinctually seek out sources of food, especially cooked food. The owner may install pet gates at entrances to the kitchen to ensure that the pet remains isolated from the kitchen letting the owner finish cooking undisturbed. However, over the last decade as of 2023, and according to the United States Census, nearly fifteen million new homes were built in the United States with various configurations. With “open concept” layouts, larger door frames, and non-standard designs becoming more prevalent, finding a one-fits-all solution for pet gates has been challenging and many existing pet access solutions are no longer adequate.

In addition to the aforementioned difficulties, many pet owners enjoy having dog breeds of varying sizes, temperaments, and energy levels. Depending on the age, training level, and previously mentioned traits of the pet, conventional gates may not be adequate. For example, conventional pet gate assemblies typically provide a flat panel or flat bar gate assembly that fits between jambs of doors. These pet gate assemblies do not effectively reduce the likelihood of pets hurdling over the gates, jumping up on the gates, or similar behaviors. In addition, conventional pet gate assemblies typically rely on hardware to mount the gate to the wall such as by screws or nails. The hardware may damage the wall, thus reducing the value of the home, and does not lend itself to quick uninstalls. Additionally, fabric or plastic based “roll-up” pet gates require hardware installation on walls, and, in addition, have a tendency to knot and fold when unrolling and re-rolling which reduces the life span of the pet gate by destroying the fabric or plastic.

The present disclosure relates to a gate assembly to partition one or more areas to limit area access to pets, such as dogs or cats, and/or children. The gate assembly may include an adaptable, dynamic, and rotatable gate portion which is angled to help mitigate and/or otherwise limit a pets ability to lean on the gate, jump over the gate, and/or climb the gate. The rotatable gate portion may include a button that may lock the rotatable gate portion at a desired angle. For example, if a pet owner has a taller dog such as Great Dane, the pet owner may angle the rotatable gate portion at a steep angle relative to the floor such that the Great Dane will have difficulty climbing on top of, or over, the gate. In another example, if a pet owner has a shorter dog such as a Blue Heeler, which are well known for their high energy and impressive jumping ability, the rotatable angle guard may be positioned at a less steep angle thus making it more difficult for the Blue Heeler to leap over the gate easily.

According to certain embodiments, the gate assembly and rotatable gate portion may function as a door which may pivot once the pet owner has released and/or engaged the button. This function may be done with as little as one hand and requires very little effort of the pet owner. Additionally, this function enables the pet owner and/or the pet to transition between rooms easily with minimal effort and risk of tripping. The gate assembly also offers modularity in that tension mechanisms may provide tension between the gate assembly and a door frame to support the gate assembly on the floor, or even above the floor. The tension mechanisms enable the gate assembly to be quickly, securely, and efficiently moved between doorways with minimal effort on the pet owners behalf. Since the tension mechanisms use reactive forces to maintain a high level of secureness of the gate assembly, pets will have difficulty knocking the gate down. Moreover, the gate assembly may include width extenders which function to extend a length of the gate assembly for wide door frames without substantial changes and/or damage to the home. In addition, the gate assembly may meet the American Society for Testing and Materials (ASTM) F1004-22 and European Safety EN1930 standards for top-tier safety for pets and children.

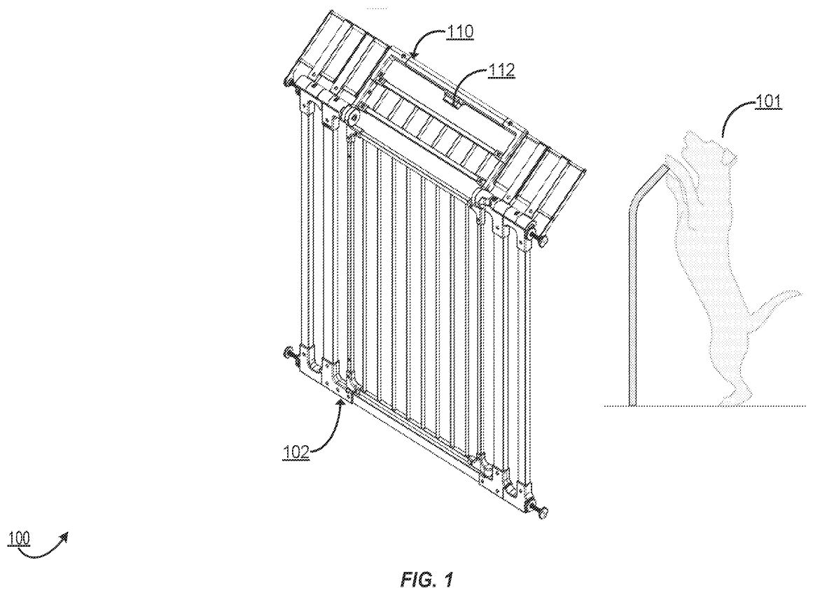

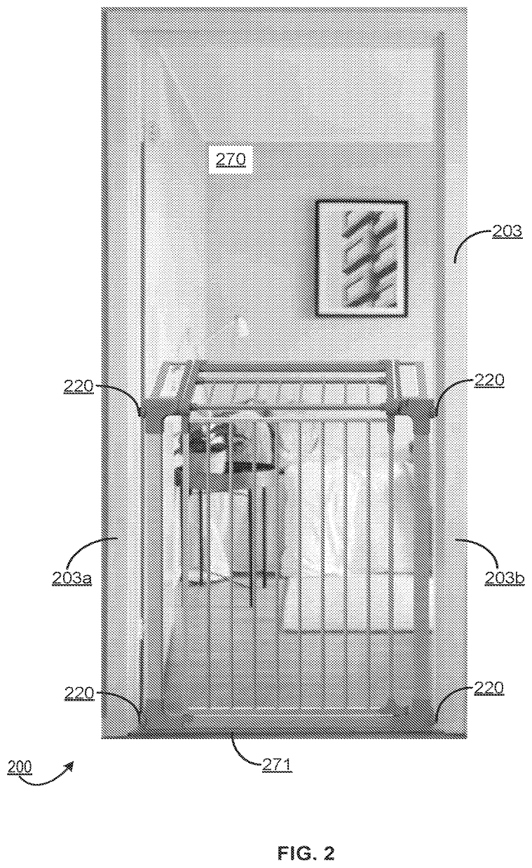

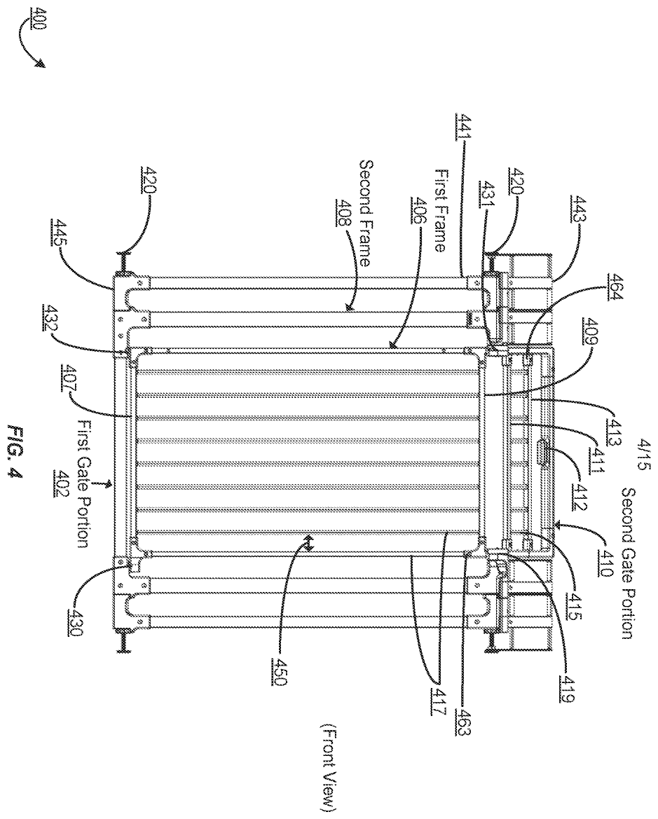

FIG. 1 is an example of a gate assembly 100, according to various embodiments. In some embodiments, the gate assembly 100 may be a pet gate for containing and/or otherwise limiting access of one or more pets 101 (e.g., dog, cat, etc.) to an area (e.g., a room). For example, the gate assembly 100 may function to keep a pet dog safely isolated in a room adjacent a kitchen by positioning the gate assembly 100 within an opening of a structure (e.g., as described in more detail in relation to FIG. 2) suitable to support the gate assembly 100 while an owner of the pet dog cooks food. The gate assembly 100 may include various components including a first gate portion 102, a second gate portion 110, and/or a locking mechanism 112 (e.g., as described in more detail in relation to FIG. 4).

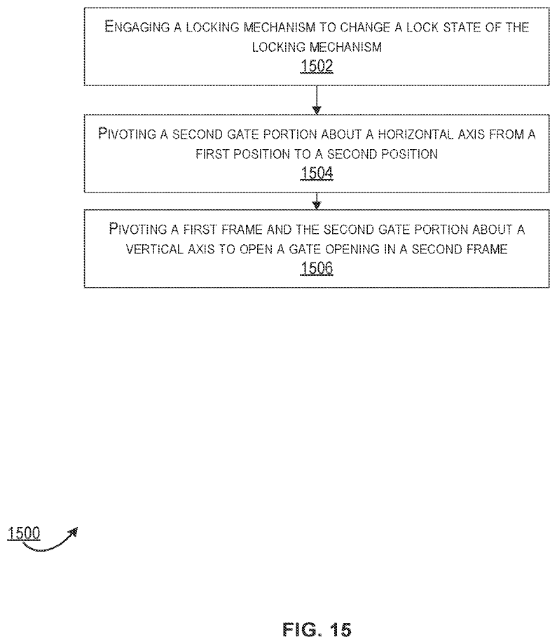

FIG. 2 is an example installation of a gate assembly 200, according to various embodiments. In some embodiments, the gate assembly 200 may be substantially the same as, or similar to, and include some or all components of the gate assemblies of FIGS. 1 and 3-14. In addition, or alternatively, the gate assembly 200 may function according to the method 1500 of FIG. 15. By way of example, the gate assembly 200 may be installed within an opening of a structure 203 in an environment 270. The structure 203 may include two opposing surfaces 203a, 203b (e.g., door jambs) suitable to support the gate assembly 200 on and/or above a horizontal surface 271. In some examples, the structure 203 may be a doorway, a throughway, an antechamber, or any suitable passageway capable of receiving the gate assembly 200. The environment 270 may be a building, a room, a subsection of a room, a partitionable area (e.g., a dog park, a vehicle, etc.), or any suitable environment which may be configured to receive an animal (e.g., a pet) and provide the two opposing surfaces 203a, 203b that may receive the gate assembly 200 using at least one tension adjuster 220 (e.g., described in more detail in reference to FIG. 4).

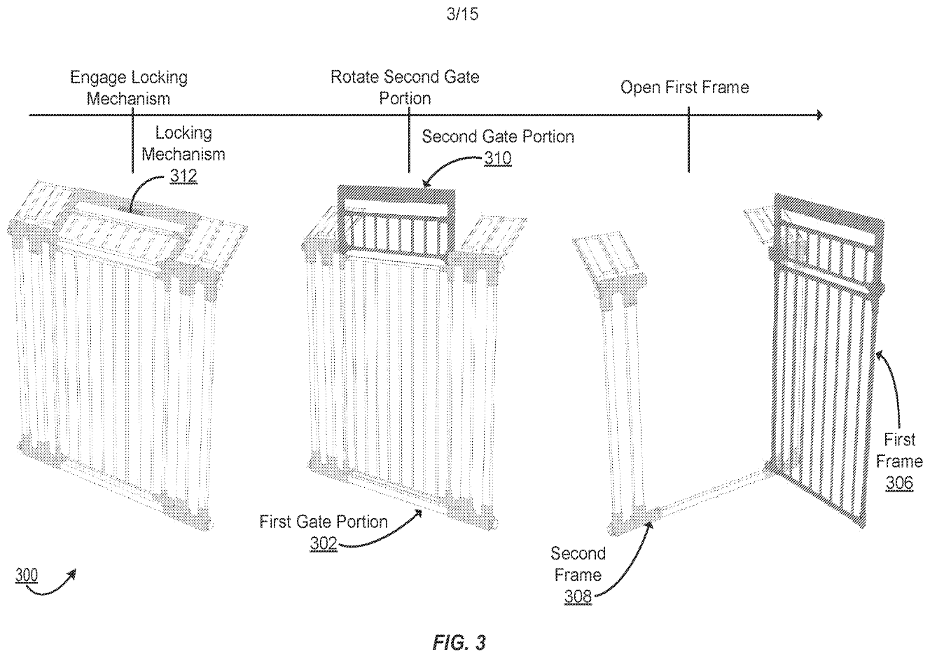

FIG. 3 is an example operation of a gate assembly 300, according to some embodiments. In some embodiments, the gate assembly 300 may be substantially the same as, or similar to, and include some or all components of the gate assemblies of FIGS. 1, 2, and 4-14. In addition, or alternatively, the gate assembly 300 may function according to the method 1500 of FIG. 15. In some examples, various operations may modify a position, angle, orientation, or combinations thereof of one or more components of the gate assembly 300. By way of example, the gate assembly 300 may include a first gate portion 302 which may include a first frame 306 (e.g., a gate door) and a second frame 308 (e.g., a support frame for a gate door). The first gate portion 302 may include the first frame 306, the second frame 308, and may have a suitable structure to support various additional components of the gate assembly 300, including a second gate portion 310. For example, the second gate portion 310 may be pivotally coupled to the first frame 306.

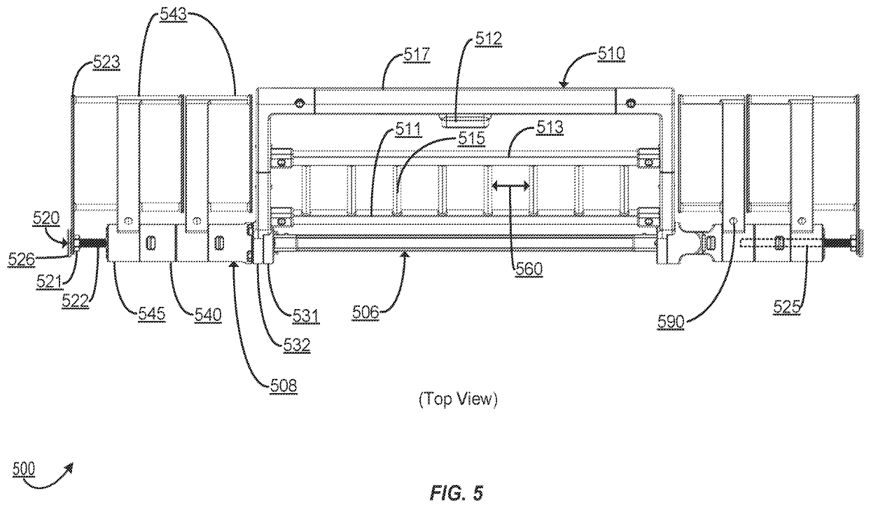

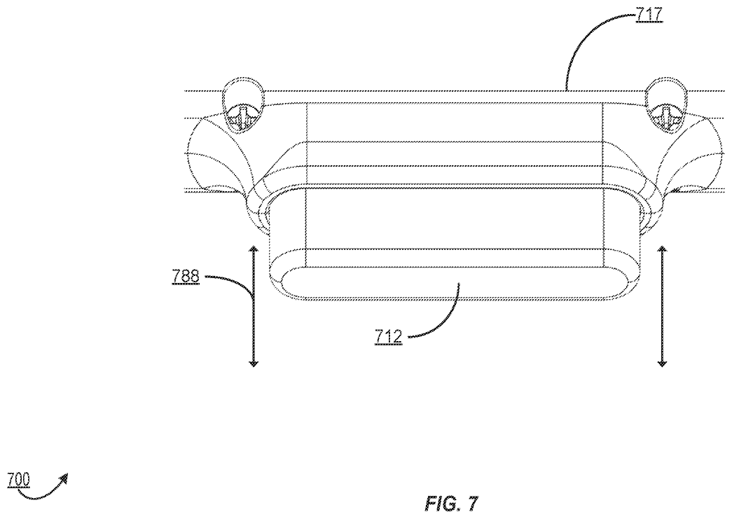

In some examples, the second gate portion 310 may include a locking mechanism 312 (described in more detail in reference to FIG. 4 and FIG. 7). The locking mechanism 312 may be arranged, at least partially, within a handle (e.g., handle 517 as depicted in FIG. 5) or any other suitable location of the second gate portion 310. The locking mechanism 312, while depicted as a button, may include other components internal to the handle and the second gate portion 310 (not depicted). In some examples, the locking mechanism 312 may include a button (e.g., button locking mechanism 712 as depicted in FIG. 7) that when actuated by a user of the gate assembly 300 may lock and/or unlock the second gate portion 310, which may be arranged in a first position angled less than 90 degrees above horizontal. The user may actuate the button of the locking mechanism 312 to permit the second gate portion 310 to counter-rotate (e.g., rotate away from the first position) to a second position that may be substantially vertical. The second gate portion 310 may rotate relative to the first frame 306 about a horizontal axis between the first position and the second position.

Further, when the second gate portion 310 is substantially vertical, the first frame 306 and the second gate portion 310 may pivot together relative to the second frame 308 about a vertical axis. Pivoting the first frame 306 and the second gate portion 310 together about the vertical axis may create an opening in the second frame 308 through which a user, (e.g., a pet owner) and/or a pet, may pass.

FIG. 4 is an example front view of a gate assembly 400, according to some embodiments. In some embodiments, the gate assembly 400 may be substantially the same as, or similar to, and include some or all components of the gate assemblies of FIG. 1-3, and 5-14. In addition, or alternatively, the gate assembly 400 may function according to the method 1500 of FIG. 15. By way of example, the gate assembly 400 may include various components including, but not limited to, a first gate portion 402, a second gate portion 410, and/or a locking mechanism 412. The first gate portion 402 may include a first frame 406 and a second frame 408. In some examples, the second frame 408 remains stationary and at least partially supports the first frame 406 and enables rotation or any other suitable movement of the first frame 406 about a connector 430. The connector 430 may be any suitable connector to enable rotation or any other movement of the first frame 406 about the second frame 408, such as, but not limited to, a male/female lock pin, a spring-loaded connector, a helical surface configured to enable rotation of the first frame 406, a corkscrew structure, or combinations thereof.

In some examples, the first frame 406 may be coupled to the second gate portion 410 such that if the first frame 406 is rotated about a vertical rotation axis relative to the second frame 408 (as depicted in FIG. 3), the second gate portion 410 moves with the first frame 406 and rotates about the vertical rotation axis as well. The second gate portion 410 may be locked in place vertically on the first frame 406 by releasing the locking mechanism 412 when the second gate portion 410 is substantially vertical. This may provide the user opening the first frame 406 by way of the second gate portion 410 may have a solid object to hold when opening and/or closing the first frame 406 about the connector 430. In some examples, the first frame 406 and/or the second frame 408 may include a first frame lock 431 and/or a second frame lock 432. The first frame lock 431 and the second frame lock 432 may be any suitable lock to enable engagement/disengagement of the first frame 406 to the second frame 408, such as, but not limited to, a male/female lock pin, a spring-loaded connector, a magnetic connector (e.g., ferromagnet), a hook, a latch, or a snap-fit connector, or combinations thereof

By way of example, the first frame lock 431 may include one or more locking locations for securely coupling the first frame 406 and the second frame 408 together. The first frame lock 431 may be in a locked state when the second gate portion 410 is in a first, non-vertical position and may be in an unlocked state when the second gate portion 410 is in a second, vertical position. The locked state of the first frame lock 431 may prevent movement of the first frame 406 relative to the second frame 408. And the unlocked state of the first frame lock 431 may permit the first frame 406 and the second gate portion 410 to pivot relative to the second frame 408.

Similarly, the second frame lock 432 may be in a locked state when the second gate portion 410 is in a first, non-vertical position and may be in an unlocked state when the second gate portion 410 is in a second, vertical position. The locked state of the second frame lock 432 may prevent movement of the first frame 406 relative to the second frame 408. And the unlocked state of the first frame lock 431 may permit the first frame 406 and the second gate portion 410 to pivot relative to the second frame 408.

In some embodiments, both the first frame lock 431 and the second frame lock 432 must be in the unlocked state to permit the first frame 406 and the second gate portion 410 to pivot together relative to the second frame 408. In further embodiments, the gate assembly 400 may include either the first frame lock 431 or the second frame lock 432.

In some examples, the first gate portion 402 may include an upper horizontal cross member 409 and a lower horizontal cross member 407. The upper horizontal cross member 409 and the lower horizontal cross member 407 may include a plurality of vertical members 417 which may be configured to couple the upper horizontal cross member 409 to the lower horizontal cross member 407. The upper cross member 409 and the lower cross member 407 may include any suitable material such as, but not limited to, metal (e.g., aluminum), plastic (e.g., polyethylene), wood, bamboo, composites, recycled materials, or combinations thereof. The upper horizontal cross member 409 and the lower horizontal cross member 407 may be made of similar materials or may be made of dissimilar materials. In some examples, the upper cross member 409 and the lower cross member 407 may be coupled together, at least partially, by one or more L-brackets 463 connected to at least one of the vertical members 417.

In some examples, the L-brackets 463 may be connected to the upper cross member 409 and the lower cross member 407 by way of, but not limited to, screws, nails, press-fits, bolts, glue, welding, or combinations thereof. The L-brackets 463 may include any suitable material such as, but not limited to, metal (e.g., aluminum), plastic (e.g., polyethylene), wood, bamboo, composites, recycled materials, or combinations thereof. In some examples, a space 450 between each vertical member 417 (e.g., edge to edge, center-to-center, etc.) may be in a range between 0.1 inches and twenty inches, or more preferably, three inches or less. Alternatively, the first frame 406 may only include two vertical member 417 at the L-brackets 463 and include at least one connection for a solid panel filling a total space therebetween the two vertical members 417. The solid panel may include any suitable material such as, but not limited to, fabric, mesh, glass, transparent polymers, metal (e.g., aluminum), plastic (e.g., polyethylene), wood, bamboo, composites, recycled materials, or combinations thereof. While this example references the use of “L-brackets”, the type and shape of bracket used should not be considered limiting. For example, any suitable type and shape of bracket and/or connector as readily recognized by one skilled in the art may be used to connect one or more components of the first frame 406. In some examples, one or more of the upper horizontal cross member 409, the lower horizontal cross member 407, or vertical members 417 may be unitary in construction (e.g., cast mold). It should be understood that while the vertical members 417 are depicted as vertical bars, it should not be considered limiting, and one skilled in the art would readily recognize that horizontal bars may be substituted and/or used in conjunction with the vertical bars. In addition, or alternatively, a patterned assortment of members may be used (e.g., crosshatch, design based, angled, etc.) instead of, or combined with, the vertical members 417.

According to various examples, the second gate portion 410 may include an upper horizontal cross member 413 and a lower horizontal cross member 411. The upper horizontal cross member 413 and the lower horizontal cross member 411 may include a plurality of vertical members 415 which may be configured to couple the upper horizontal cross member 413 to the lower horizontal cross member 411. The upper cross member 413 and the lower cross member 411 may include any suitable material such as, but not limited to, metal (e.g., aluminum), plastic (e.g., polyethylene), wood, bamboo, composites, recycled materials, or combinations thereof. The upper horizontal cross member 413 and the lower horizontal cross member 411 may be made of similar materials or may be made of dissimilar materials. In some examples, the upper horizontal cross member 413 and the lower horizontal cross member 411 may be connected together, at least partially, by one or more brackets 464 connected to at least one of the vertical members 415.

In some examples, the brackets 464 may be connected to the upper cross member 413 and the lower cross member 411 by way of, but not limited to, screws, nails, press-fits, bolts, glue, welding, or combinations thereof. The brackets 464 may include any suitable material such as, but not limited to, metal (e.g., aluminum), plastic (e.g., polyethylene), wood, bamboo, composites, recycled materials, or combinations thereof. While this example references the use of “brackets”, the type and shape of bracket used should not be considered limiting. For example, any suitable type and shape of bracket and/or connector as readily recognized by one skilled in the art may be used to connect one or more components of the second gate portion 410. In some examples, one or more of the upper horizontal cross member 413, the lower horizontal cross member 411, or vertical members 415 may be unitary in construction (e.g., cast mold). In addition, or alternatively, the handle (e.g., handle 517 of FIG. 5) of the second gate portion 410 may be unitary in construction with one or more of the upper horizontal cross member 413, the lower horizontal cross member 411, or vertical members 415. Alternatively, the second gate portion 410 may not include any vertical members 415 at the brackets 464 and/or the upper horizontal cross member 413 or the lower horizontal cross member 411. In yet another alternative example, the second gate portion 410 may include at least one connection for a solid panel filling a total space therebetween two sides defined by a width of a handle (e.g., handle 517 as depicted in FIG. 5) of the second gate portion 410. The solid panel may include any suitable material such as, but not limited to, fabric, mesh, glass, transparent polymers, metal (e.g., aluminum), plastic (e.g., polyethylene), wood, bamboo, composites, recycled materials, or combinations thereof.

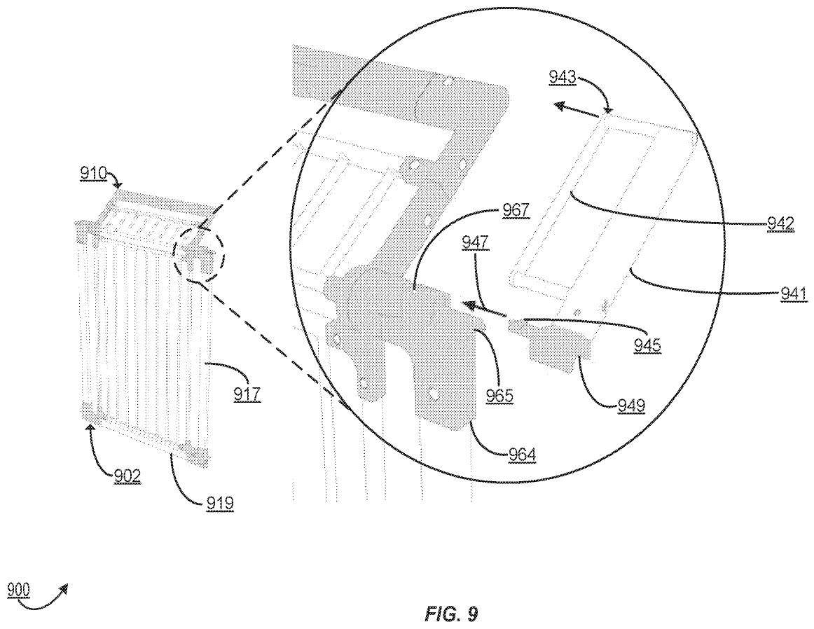

In some examples, the second frame 408 may be configured to couple to one or more width extenders 441. The width extenders 441 may connect to the second frame 408 at one or more corners that may include brackets (discussed in more detail in FIG. 9). The width extenders 441 may be positioned between the second frame 408 and a structure (e.g., structure 203 in FIG. 2) in order to widen and support upright positioning of the gate assembly 400. Each of the width extenders may include an angle guard 443 which may be angled with respect to the vertical axis substantially in line with the second gate portion 410 when the second gate portion 410 is in a first position (e.g., a non-zero/non-ninety degree angle with respect to a horizontal surface). In some examples, the angle guards 443 remain stationary with respect to the width extenders 441. In other examples, the angle guards 443 may rotate with the second gate portion 410 when the locking mechanism is engaged/disengaged. In some examples, additional width extenders may be coupled to the width extenders 441 in other to extend the second frame 408 an additional length as an integer number of width extenders 441. The second frame 408, width extender 441, additional width extenders 445, or combinations thereof, may include one or more tension adjusters 420. The tension adjusters 420 may substantially pass through and into second frame 408, width extender 441, additional width extenders 445, or combinations thereof, in order to couple the second frame 408 to the structure (not depicted). It should be understood by one skilled in the art that each width extender 441 and each additional width extender 445 may be similar, and/or substantially the same and the term “additional” is intended to describe the next outer width extender from the gate assembly 400.

In some examples, the gate assembly 400 may include an outer width dimension in a range between fifteen inches and forty eight inches measured from a first tension adjuster 420 to a second opposite tension adjuster 420. In addition, or alternatively, the gate assembly may include a height dimension in a range of fifteen inches to seventy-two inches from a horizontal surface the gate assembly 400 is in contact with or positioned above to the second gate portion 410 when in the second, vertical position. In some examples, each tension adjuster 420 may include a wheel mechanism that may be configured to rotate (e.g., counter-clockwise or clockwise) to adjust a horizontal position of the tension adjuster 420 (e.g., relative to a floor of the environment) until the tension adjuster 420 has a suitably secure connection with a location on one of the two opposing surfaces such as surfaces of a door jamb. By rotating each wheel mechanism, each tension adjuster 420 may form a suitable secure and reliable connection with unique individual location on the structure. The tension adjusters 420 may be individually adjusted to account for structures which are not square or are otherwise a non-rectangular shape such as when a first location close to a horizontal surface (e.g., a floor) has a horizontal width smaller than a second location farther from the horizontal surface. The tension adjusters 420 may function in tandem to provide opposing forces from the two opposing surfaces which may enable the gate assembly 400 remains substantially immovable between the two opposing surfaces. In some examples, the gate assembly 400 may be substantially suspended above the horizontal surface using the tension adjusters 420 to a user selected height or may be at least partially supported by the horizontal surface and securely held in place using the tension adjusters 420.

FIG. 5 is an example top view of a gate assembly, according to some embodiments. In some embodiments, the gate assembly 500 may be substantially the same as, or similar to, and include some or all components of the gate assemblies of FIG. 1-4, and 6-14. In addition, or alternatively, the gate assembly 500 may function according to the method 1500 of FIG. 15. In some examples, the gate assembly 500 may include a handle 517 that includes a locking mechanism 512. For example, the handle 517 may form at least part of the second gate portion 510. The handle 517 may include any suitable material such as, but not limited to, metal (e.g., aluminum), plastic (e.g., polyethylene), wood, bamboo, composites, recycled materials, or combinations thereof. The handle 517 may include an encapsulation and/or protection layer that at least partially covers and/or protects the handle 517 from wear and/or damage which may occur during use. The locking mechanism 512 may be at least partially enclosed within the handle 517 and be configured to actuate the second gate portion 510 between a first position (e.g., angled with respect to horizontal) and a second position (e.g., parallel with a first frame 506 along the vertical axis).

In some examples, the second gate portion 510 may include an upper horizontal cross member 513 and a lower horizontal cross member 511. The upper horizontal cross member 513 and the lower horizontal cross member 511 may include a plurality of vertical members 515 which may be configured to couple the upper horizontal cross member 513 to the lower horizontal cross member 511. In some examples, a space 560 between each vertical member 515 (e.g., measured edge to edge, center-to-center, etc.) may be in a range between 0.1 inches to twenty inches, or more preferably, three inches or less.

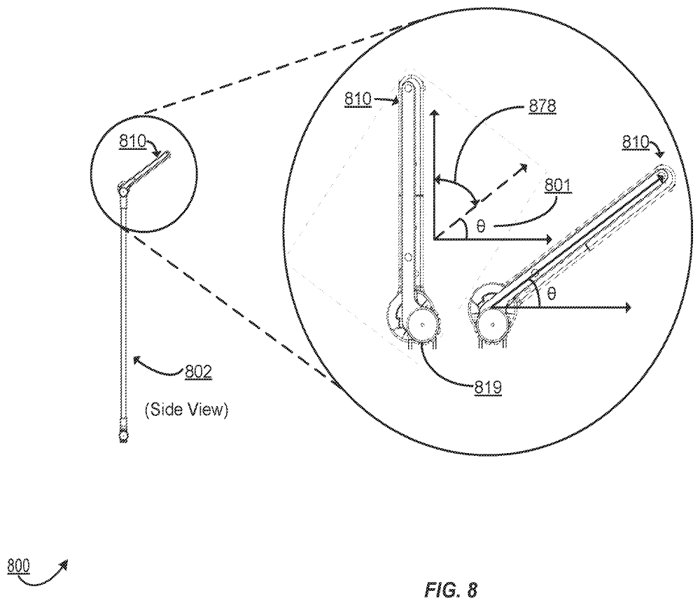

The second gate portion 510 may rotate (as depicted in FIG. 3) relative to the first frame 506 via a first rotation connector 531 and a second rotation connector 532. For example, when the locking member 512 is engaged (e.g., compressed), and the second gate portion 510 is rotated to the second position, the first rotation connector 531 rotates with respect the second rotation connector 532. The first rotation connector 531 and the second rotation connector 532 may include gear-latch connectors which may have distinct locking angles (as discussed further in reference to FIG. 8) for positioning the second gate portion 510 in relation to the first frame 506 and a second frame 508. It should be understood that the mechanism to enable rotation between the first rotation connector 531 and the second rotation connector 532 may be any suitable rotation mechanism such as, but not limited to, gear mechanisms, spring mechanisms, pully mechanisms, tension mechanisms, wire mechanisms, snap-fit mechanisms, or combinations thereof.

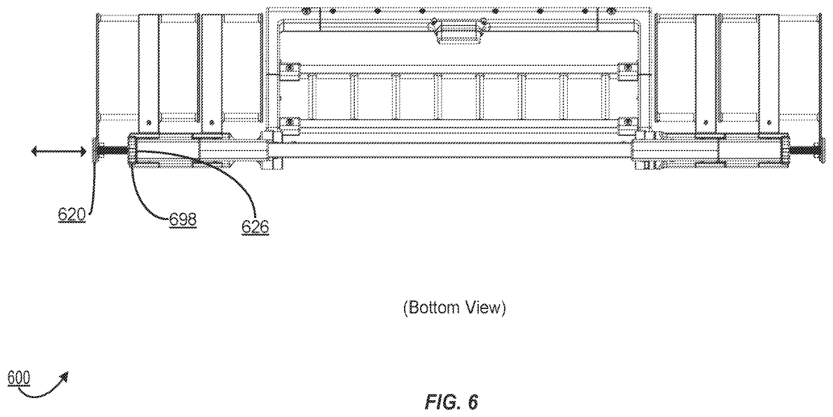

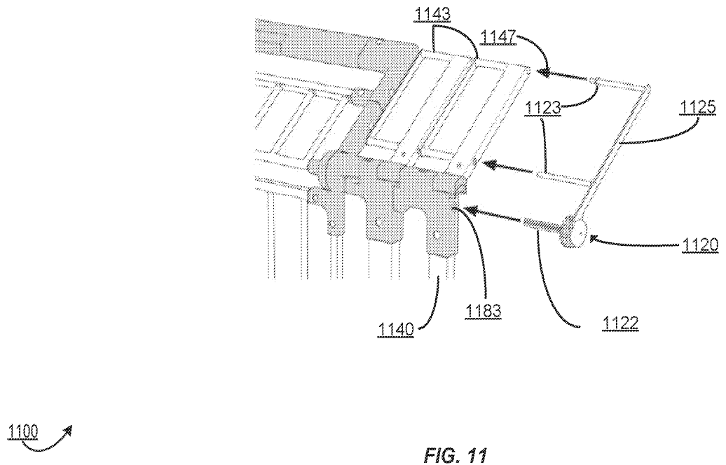

In some examples, the second gate portion 510 may include one or more width extenders 540. Each width extender 540 may be configured to connect to the second frame 508 and may include an angle guard 543. The width extenders 540 may be configured to couple to one or more additional width extenders 545. For example, the second frame 508 may include a connection (e.g., dovetail, snap-fit, etc.) to connect to the width extender 540 which may use substantially the same connection for the additional width extender 545. The second frame 508, the width extender 540, and/or the additional width extender 545 may be configured to couple to at least some components of one or more tension adjusters 520. For example, the tension adjusters 520 may include a wheel mechanism 526 with coarse and/or smooth depressions and/or bumps (e.g., bumps 698 as depicted in FIG. 6) to enable a good firm grip for a user that may rotate the wheel mechanism 526 to adjust the tension adjusters 520. The tension adjusters 520 may be configured to receive the angle guards 523 by passing an adjuster base 522 through a hole (e.g., 1183 in FIG. 11), and securing the angle guard 523 to the tension adjuster 520 using first fasteners 521 (e.g., bolt, nut, washer, etc.). In addition, or alternatively, second frame 508, the width extender 540, and/or the additional width extender 545, the angle guards 543, and tension adjusters 520 may be secured together using second fasteners 590 screws, nails, press-fits, bolts, glue, welding, or combinations thereof. The adjuster base 522 may be secured to the second frame 508, the width extender 540, and/or the additional width extender 545, or combinations thereof as depicted by adjuster base cross-section 525.

FIG. 6 is an example bottom view of a gate assembly, according to some embodiments. In some embodiments, the gate assembly 600 may be substantially the same as, or similar to, and include some or all components of the gate assemblies of FIG. 1-5, and 7-14. In addition, or alternatively, the gate assembly 600 may function according to the method 1500 of FIG. 15. In some examples, the gate assembly 600 may include one or more tension adjusters 620 which may include wheel mechanisms 626. The wheel mechanisms 626 may include bumps 698 to enable a user to rotate the tension adjuster 620 more easily. As the wheel mechanisms 626 are rotated clockwise and/or counter-clockwise, the tension adjusters 620 may translate horizontally parallel to a surface (e.g., horizontal surface 271 as depicted in FIG. 2).

FIG. 7 is an example button locking mechanism 700 of a gate assembly, according to some embodiments. In some embodiments, the gate assembly may be substantially the same as, or similar to, and include some or all components of the gate assemblies of FIG. 1-6, and 8-14. In addition, or alternatively, the gate assembly and/or button locking mechanism 700 may function according to the method 1500 of FIG. 15. In some examples, the gate assembly may include a locking mechanism 712. The locking mechanism 712 may include a compressible button configured to be compressed by a user of the gate assembly. In addition, or alternatively, the locking mechanism 712 may include any suitable actuator including, but not limited to, a toggle, a switch throw (e.g., single, double, etc.), gear mechanisms, spring mechanisms, pully mechanisms, tension mechanisms, wire mechanisms, snap-fit mechanisms, or combinations thereof.

By way of example, if a button is used as the locking mechanism 712, compressing the button may unlock rotation of a second gate portion (e.g., second gate portion 310 as depicted in FIG. 3) whereas releasing the button may lock rotation of the second gate portion (discussed in more detail in reference to FIG. 8). In addition, or alternatively, the locking mechanism 712 may be compressed from an initial position to a first position along movement direction 788 which may unlock free rotation of the second gate portion until the locking mechanism 712 is compressed to a higher second position along the movement direction 788 where the second gate portion may lock at the nearest rotation angle. Once the locking mechanism 712 has reached the second position, it may freely return to the initial position. In some examples, the locking mechanism 712 and associated components may be at least partially enclosed by a handle 717. The locking mechanism 712 may span a few inches of the handle 717 up to a few feet of the handle 717. The locking mechanism 712 and components thereof may include any suitable material such as, but not limited to, metal (e.g., aluminum), plastic (e.g., polyethylene), wood, bamboo, composites, recycled materials, or combinations thereof.

FIG. 8 is an example rotation mechanism side view of a rotation operation of a gate assembly 800, according to some embodiments. In some embodiments, the gate assembly 800 may be substantially the same as, or similar to, and include some or all components of the gate assemblies of FIG. 1-7, and 9-14. In addition, or alternatively, the gate assembly 800 may function according to the method 1500 of FIG. 15. In some examples, a second gate portion 810 may rotate with respect to a first gate portion 802 to an angle 801 θ between zero and ninety degrees. The second gate portion 810 may include a rotation connector 819, which may be the same as and/or include some or all components of the first rotation connector 531 and the second rotation connector 532 of FIG. 5. In addition, or alternatively, the rotation mechanism 819 may enable the second gate portion 810 to rotate through a pivot range 878 of angles θ beyond ninety degrees including up to one hundred and eighty degrees from a horizontal surface (e.g., horizontal surface 271). In some examples, rotation of the second gate portion 810 may include one or more intermediate rotation “stops” that may somewhat limit, provide feedback pressure, and/or otherwise stop the second gate portion 810 from rotating. As an example, the rotation stops may be every five degrees, every ten degrees, and/or may be at common angles such as ten degrees, twenty five degrees, forty five degrees, or sixty degrees to help a user determine an optimal angle for the second gate portion for their pet. By way of a non-limiting example, actuation of a locking mechanism (e.g., locking mechanism 712 as depicted in FIG. 7), may enable rotation of the second gate portion 810 to angles between twenty five degrees and sixty five degrees above the horizontal surface, which may reduce the likelihood that a pet attempts to jump and/or climb the gate assembly 800.

FIG. 9 is an example of an operation 900 to connect an angle guard 943 of a gate assembly, according to some embodiments. In some embodiments, the gate assembly may be substantially the same as, or similar to, and include some or all components of the gate assemblies of FIG. 1-8, and 10-14. In addition, or alternatively, the gate assembly and/or angle guard may function according to the method 1500 of FIG. 15. In some examples, the gate assembly may include a first gate portion 902 and a second gate portion 910. The first gate portion 902 may include one or more corner L-brackets 964. The corner L-brackets 964 may be connected to one or more vertical members 917 and/or one or more horizontal members 919 by way of, but not limited to, screws, nails, press-fits, bolts, glue, welding, or combinations thereof. The corner L-brackets 964 may include any suitable material such as, but not limited to, metal (e.g., aluminum), plastic (e.g., polyethylene), wood, bamboo, composites, recycled materials, or combinations thereof. While this example references the use of “L-brackets”, the type and shape of bracket used should not be considered limiting. For example, any suitable type and shape of bracket and/or connector as readily recognized by one skilled in the art may be used to connect one or more components. In some examples, one or more of the vertical member 917, the horizontal member 919, or corner L-brackets 964 may be unitary in construction (e.g., cast mold).

In some examples, the corner L-brackets 964 may include a first connection surface 965 and a second connection surface 967. The first connection surface 965 may include a complementary surface to an angle guard connection surface 949 suitable to ensure a good connection. In a non-limiting example, the first connection surface 965 may include a convex geometry in order to receive a corresponding concave angle guard connection surface 949 (e.g., a dovetail connection) when the angle guard 943 is moved to connect with the corner L-bracket 964 along direction 947. In some examples, the angle guard 943 may include a connector 945 configured to connect and/or otherwise securely join the angle guard 943 with the corner L-bracket 964 at the second connection surface 967. The second connection surface 967 may include, but is not limited to, any suitable connection such as a hole, a protrusion, a depression, a snap-fit, a hook, a lock-pin, or combinations thereof. Similarly, the connector 945 may include, but is not limited to, any suitable complementary connection such as a hole, a protrusion, a depression, a snap-fit, a hook, a lock-pin, or combinations thereof. In a non-limiting example, the second connection surface 967 may be a hole which receives a protrusion of the connector 945 such that when the second connection surface 967 and the connector 945 are brought together a secure and reliable snap-fit connection is created as the protrusion locks into the hole.

In some examples, the angle guard 943 may include an extension 942. The extension 942 may be configured to fill a gap between the second gate portion 910 and an angle guard body 941. The extension 942 may be substantially hollow or may contain a solid panel filling a total space therebetween. The solid panel may include any suitable material such as, but not limited to, fabric, mesh, glass, transparent polymers, metal (e.g., aluminum), plastic (e.g., polyethylene), wood, bamboo, composites, recycled materials, or combinations thereof. In some examples, the angle guard body 941, the extension 942, and/or the angle guard connection surface 949 may include any suitable material such as, but not limited to, metal (e.g., aluminum), plastic (e.g., polyethylene), wood, bamboo, composites, recycled materials, or combinations thereof. While this example references the use of extensions, connection surfaces, or similar, the type and shape of the surfaces or extensions used should not be considered limiting. For example, any suitable type and shape of surface and/or extension as readily recognized by one skilled in the art may be used to connect one or more components. In some examples, one or more of the angle guard body 941, the extension 942, and/or the angle guard connection surface 949 may be unitary in construction (e.g., cast mold).

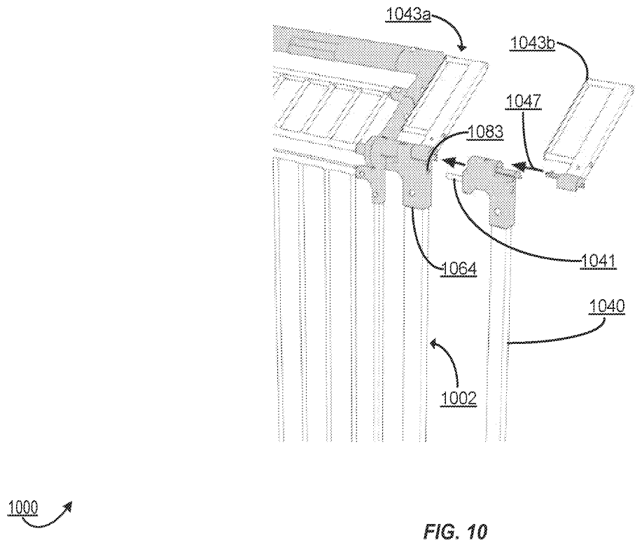

FIG. 10 is an example operation 1000 for connecting an additional width extender 1040 to a gate assembly, according to some embodiments. In some embodiments, the gate assembly may be substantially the same as, or similar to, and include some or all components of the gate assemblies of FIG. 1-9, and 11-14. In addition, or alternatively, the gate assembly and/or width extender may function according to the method 1500 of FIG. 15. In some examples, the additional width extender 1040 may connect to a corner L-bracket 1064 of a first gate portion 1002 by way of an extender connector 1041 connecting to a bracket connector 1083. In a non-limiting example, the extender connector 1041 and/or the bracket connector 1083 may include, but is not limited to, any suitable complementary connections such as a hole, a protrusion, a depression, a snap-fit, a hook, a lock-pin, or combinations thereof. By way of example, the extender connector 1041 may be a pin which is received in the bracket connector 1083 which may be a hole when the additional width extender 1040 is moved along direction 1047. In some examples, the additional width extender 1040 may include an angle guard 1043b. The connection between the additional width extender 1040 and the angle guard 1043b may be the same as, and/or substantially similar to the connection configuration as depicted in FIG. 9. The angle guard 1043b may be angled at a same angle as the angle guard 1043a and substantially close a gap as the angle guard 1043b is moved along direction 1047.

FIG. 11 is an example operation 1100 for attaching a tension adjuster 1120 to a gate assembly, according to some embodiments. In some embodiments, the gate assembly may be substantially the same as, or similar to, and/or include some or all components of the gate assemblies of FIG. 1-10, and 12-14. In addition, or alternatively, the gate assembly may function according to the method 1500 of FIG. 15. By way of example, the tension adjuster 1120 may function to couple the gate assembly to a structure (e.g., structure 203 as depicted FIG. 2) when additional width extenders (e.g., additional width extender 1040 as depicted in FIG. 10) are added to the gate assembly to account for structures with larger gaps than the gate assembly can reliably be supported between (e.g., non-standard doorways). In some examples, the tension adjuster 1120 may include an angle guard lock 1125 which may include one or more guides 1123 and an adjuster base 1122 for securely and reliably coupling the tension adjuster 1120 to an additional width extender 1140 which may include an extender connector 1183. In a non-limiting example, the extender connector 1183 may be a hole which receives a guide 1123 such that when the extender connector 1183 and the guide 1123 are brought together along direction 1147, a secure and reliable connection is created as the guide 1123 locks into the hole. In some examples, the guides 1123 of the angle guard lock 1125 may enter one or more of the angle guards 1143 and secure respective positions.

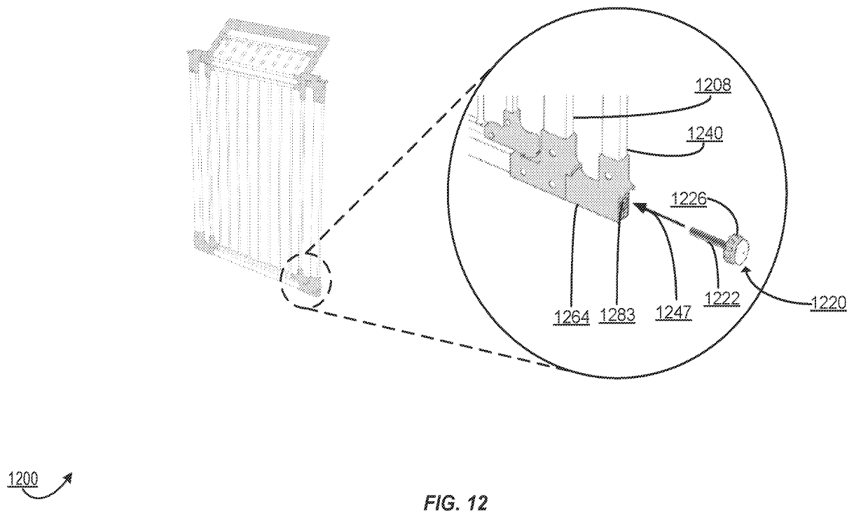

FIG. 12 is an example operation 1200 of installing a tension adjuster 1220 of a gate assembly, according to some embodiments. In some embodiments, the gate assembly may be substantially the same as, or similar to, and/or include some or all components of the gate assemblies of FIG. 1-11, 13, and 14. In addition, or alternatively, the gate assembly may function according to the method 1500 of FIG. 15. In some examples, the tension adjuster 1220 may include at least an adjuster base 1222 and a wheel mechanism 1226. The adjuster base 1222 may be received by a corner L-bracket 1264 of a first frame 1208 and/or an additional width extender 1240. The adjuster base 1222 may be threaded and connect with a slot 1283 in the corner L-bracket 1264 along direction 1247. The tension adjuster 1220 may be rotated, via the wheel mechanism 1226 to adjust a lateral position, and, in addition or alternatively, couple the gate assembly to a structure (e.g., structure 203 as depicted in FIG. 2). In some examples, the gate assembly includes any suitable number of tension adjusters 1220 in order to securely fasten the gate assembly to the structure.

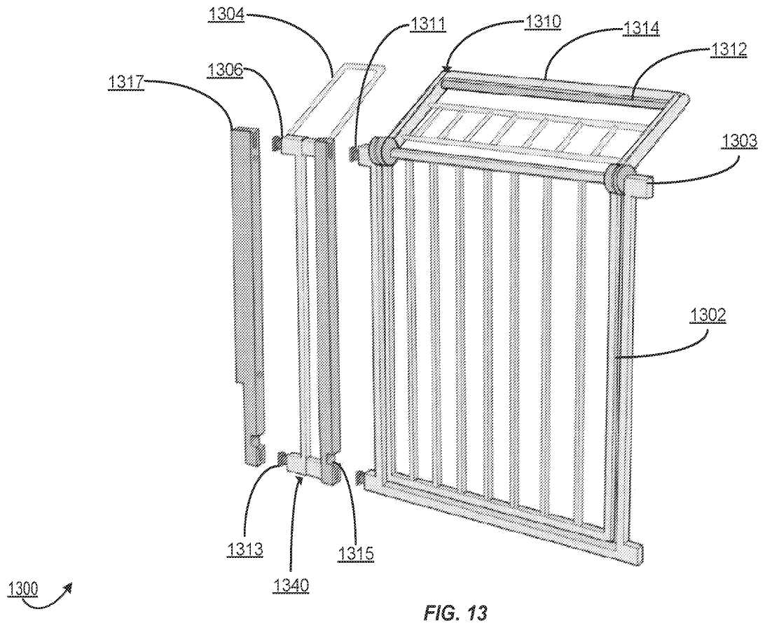

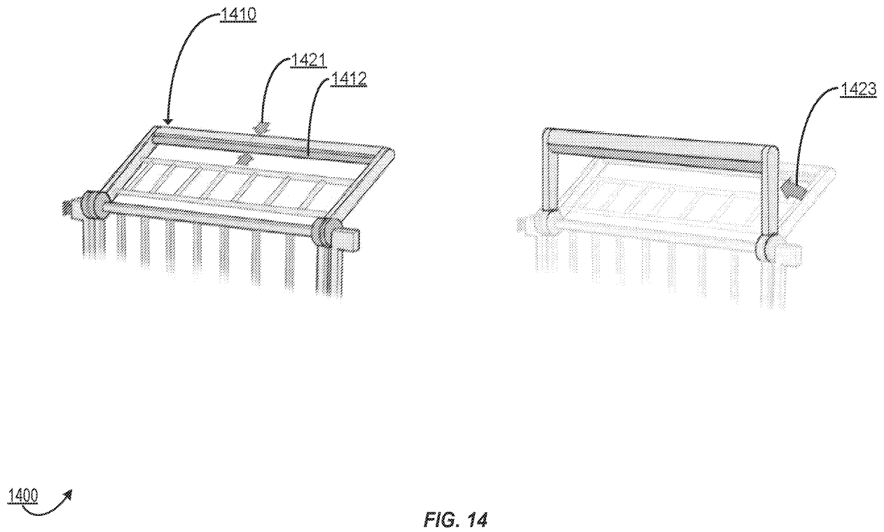

FIG. 13 is an example alternate gate assembly 1300, according to some embodiments. In some embodiments, the gate assembly 1300 may be substantially the same as, or similar to, and/or include some or all components of the gate assemblies of FIG. 1-12, and 14. In addition, or alternatively, the gate assembly 1300 may function according to the method 1500 of FIG. 15. In some examples, the gate assembly 1300 may include a handle 1314 with a locking mechanism 1312. The locking mechanism 1312 may extend along a width of the handle 1314. For example, the locking mechanism 1312 may extend along 100%, 90%, 80%, 70%, etc., along the width of the handle 1314. The locking mechanism 1312 may include one or more biasing components to provide an even and firm compression when used by a user of the gate assembly 1300 such as when rotating a second gate portion 1310 between a first position and a second position (e.g., rotation 1423 in reference to FIG. 14). A first gate portion 1302 may include one or more structure connections 1303. The structure connections 1303 may be slot type connects for corresponding connectors on a structure. For example, each of the structure connections 1303 may be a male-type connector that slots into a female-type connector that is separately attached to a structure (not depicted).

The first gate portion 1302 may also include one or more latches 1311 to connect to one or more width extenders 1340. For example, each latch 1311 may connect to an extender connector 1315 using a slot configuration. The latches 1311 may be received at least partially within the extender connectors 1315 using an upward motion to position the gate assembly 1300 and then applying a downward motion once the latches 1311 are aligned to slot the latches 1311 into the extender connectors 1315. In addition, or alternatively, the width extenders 1340 may include one or more additional extender connectors 1313 and one or more angle guards 1304. The additional extender connectors 1313 may attach to one or more additional width extenders (not depicted) and/or may attach directly to the structure using any suitable connection means. In some examples, the structure may have an attachment guide 1317 for slotting either the width extenders 1340 and/or the additional width extenders to support the gate assembly 1300.

FIG. 14 is an example alternate second gate portion 1410 of a gate assembly 1400, according to some embodiments. In some embodiments, the gate assembly 1400 may be substantially the same as, or similar to, and/or include some or all components of the gate assemblies of FIG. 1-13. In addition, or alternatively, the gate assembly 1400 may function according to the method 1500 of FIG. 15. In some examples, the second gate portion 1410 may include a locking mechanism 1412 that may be actuated along any length of the locking mechanism 1412 by an action 1421. The action 1421 may include a compression, a squeeze, a toggle, or any suitable action 1421 that may actuate the locking mechanism 1412 to enable rotation 1423 of the second gate portion 1410.

FIG. 15 is an example method 1500 for operating a gate assembly, according to some embodiments. By way of example, the method 1500 may be performed, at least in part, by any suitable combination of the gate assemblies of FIG. 1-14. In some embodiments, the method 1500 may include more or fewer steps than the number depicted in FIG. 15. It should be appreciated that the steps of the method 1500 may be performed in any suitable order.

The method 1500 may begin at step 1502 where a user of the gate assembly may engage a locking mechanism to change a lock state of the locking mechanism. For example, a user may grab a handle of the gate assembly with one or both hands and actuate the locking mechanism to release and/or engage one or more internal locking members that prevent/enable the handle/second gate portion from rotating. In some examples, the locking mechanism may remain unlocked and/or locked until the locking mechanism is re-actuated by the user.

At step 1504, the user grasping the handle may pivot a second gate portion about a horizontal axis from a first position to a second position. For example, the user may pull and/or push the handle of the gate assembly towards and/or away from the user to rotate of the second gate portion. The action of pulling and/or pushing the second gate portion may be performed by a single hand of a user or by both hands of a user. The second gate portion may include any suitable mechanism to aid the user in rotating the second gate portion such as, but not limited to, spring loaded members, gear latch members, and/or tension straps.

At step 1506, once the second gate portion has reached the second position, e.g., the second gate portion is vertically aligned, a first frame of the gate assembly may be pivoted about a vertical axis towards and/or away from the user. Since the second gate portion is coupled to the first frame, the second gate portion also pivots about the vertical axis towards and/or away from the user. By performing this rotation, an opening is created in the second frame that enables a user and/or pet of the user to freely pass through the gate assembly.

The terms and expressions which have been employed are used as terms of description, not of a form of limitation, and there is no intention in the use of such terms and expressions of excluding any equivalents of the features shown and described or portions thereof, but it should be recognized by those skilled in the art that various modifications are possible within the scope of the claims. Thus, it should be understood that although the present disclosure includes specific embodiments and optional features, modification and variation of the concepts herein disclosed may be implemented to by those skilled in the art, and that such modifications and variations are considered to be within the scope of the claims and description.

As used in this application and in the claims, the singular forms “a”, “an”, and “the” include the plural forms unless the context clearly dictates otherwise. Additionally, the term “includes” means “comprises”. Further, the term “coupled” does not exclude the presence of intermediate elements between the coupled items. In some examples, values, procedures, or devices are referred to by comparisons to other values, procedures, or devices. It will be appreciated that such descriptions are intended to indicate that a selection among many used functional alternatives can be made, and such selections need not be better, smaller, or otherwise preferable to other selections. Additionally, the description sometimes uses terms like “produce” and “provide” or similar to describe the disclosed methods. These terms should be considered high-level abstractions of the actual operations that are performed. The actual operations that correspond to these terms may vary depending on the particular implementation and are readily discernible by one or ordinary skill in the art.

The systems, apparatuses, and methods described herein should not be construed as limiting in any way. Instead, the present disclosure is directed toward all novel and non-obvious features and aspects of the various disclosed embodiments, alone and in various combinations and sub-combinations with one another. The disclosed gate assemblies, components thereof, operations, and methods are not limited to any specific aspect or feature or combinations thereof, nor do the disclosed gate assemblies, components thereof, operations, and methods require that any one or more specific advantages be present or problems be solved. Any theories of operation are to facilitate explanation, but the disclosed gate assemblies, components thereof, operations, and methods are not limited to such theories of operation.

Although the operations of some of the disclosed gate assemblies, components thereof, operations, and methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed gate assemblies, components thereof, operations, and methods may be used in conjunction with other gate assemblies, components thereof, operations, and methods.

Where terms are used without explicit definition, it is understood that the ordinary meaning of the word is intended, unless a term carries a special and/or specific meaning in the field of charged particle microscopy systems or other relevant fields. The terms “approximately”, “same”, “about”, “similar”, or “substantially” are used to indicate a deviation from the stated property or numerical value within which the deviation has little to no influence of the corresponding function, property, or attribute of the structure being described. In an illustrated example, where a value is described as “substantially equal” or “approximate” to another value, the term “substantially” or “approximate” is intended to reflect that the two values being compared can be unequal within a percentage (e.g., +/−ten percent).

The description provides exemplary embodiments, and is not intended to limit the scope, applicability or configuration of the gate assemblies, components thereof, operations, and methods. Rather, the ensuing description of the exemplary embodiments will provide those skilled in the art with an enabling description for implementing various embodiments. It is understood that various changes may be made in the function and arrangement of elements without departing from the spirit and scope as set forth in the appended claims. In addition, specific details are given in the description to provide a thorough and detailed understanding of the embodiments. However, it will be understood that the embodiments may be practiced without these specific details. For example, specific gate assemblies, components thereof, operations, and methods, and other elements of the present disclosure may be shown in schematic diagram form or omitted from illustrations in order not to obscure the embodiments in unnecessary detail. In other instances, well-known circuits, processes, components, structures, and/or techniques may be shown without unnecessary detail.

Different arrangements of the components depicted in the drawings or described above, as well as components and steps not shown or described are possible. Similarly, some features and sub-combinations are useful and may be employed without reference to other features and sub-combinations. Embodiments and alternate embodiments herein have been described for illustrative and not restrictive purposes. Accordingly, the present description is not limited to the embodiments described above or depicted in the drawings, and various embodiments and modifications may be made without departing from the scope of the claims below.

That which is claimed is:

1. A gate assembly comprising:
a first gate portion including a first frame and a second frame, the first gate portion being positionable within an opening of a structure and couplable to the structure;
a second gate portion pivotally coupled to the first frame, wherein the second gate portion is pivotable about a horizontal axis between a first position and a second position;
a locking mechanism arranged at least partly within the second gate portion and configured to lock the second gate portion in at least the first position, wherein in the first position the second gate portion is arranged at an angle less than 90 degrees above horizontal; and
wherein pivoting the second gate portion to the second position permits the first frame and the second gate portion to pivot about a vertical axis and open a gate opening in the second frame.

2. The gate assembly of claim 1, wherein the angle is between 25 degrees and 65 degrees above horizontal.

3. The gate assembly of claim 1, wherein the first gate portion and the second gate portion each include an upper horizontal cross member, a lower horizontal cross member, and a plurality of vertical members extending between the upper horizontal cross member and the lower horizontal cross member, with a space between each vertical member of the plurality of vertical members being 3 inches or less.

4. The gate assembly of claim 1, wherein the locking mechanism includes a button and the locking mechanism is releasable by compressing the button.

5. The gate assembly of claim 1, wherein the locking mechanism includes a locked state and an unlocked state, and in the unlocked state the second gate portion is pivotable between the first position and the second position.

6. The gate assembly of claim 1, further comprising:
a width extender couplable to the second frame and positionable between the second frame and the structure; and
a first angle guard coupled to the width extender and positioned at the same angle as the second gate portion in the first position.

7. The gate assembly of claim 6, further comprising an additional width extender couplable to the width extender.

8. The gate assembly of claim 1, further comprising a first angle guard coupled to the second frame, arranged on a first side of the second gate portion, and positioned at the same angle as the second gate portion in the first position.

9. A gate assembly comprising:
a first gate portion including a first frame and a second frame, wherein the first gate portion is positionable within an opening of a structure and couplable to the structure; and
a second gate portion extending from the first frame, wherein the second gate portion is arranged at an angle less than 90 degrees above horizontal.

10. The gate assembly of claim 9, wherein the first gate portion and the second gate portion each include an upper horizontal cross member, a lower horizontal cross member, and a plurality of vertical members extending between the upper horizontal cross member and the lower horizontal cross member, with a space between each vertical member of the plurality of vertical members being 3 inches or less.

11. The gate assembly of claim 9, wherein the second gate portion is pivotally coupled to the first frame, the second gate portion being pivotable about a horizontal axis between a first position and a second position.

12. The gate assembly of claim 11, wherein the second gate portion includes a locking mechanism comprising a locked state and an unlocked state, and, in the locked state, the second gate portion is not pivotable between the first position and the second position.

13. The gate assembly of claim 9, further comprising a tension adjuster including a wheel mechanism disposed on a corner of the second frame, wherein adjusting the wheel mechanism moves the tension adjuster along a horizontal direction.

14. The gate assembly of claim 13, wherein the wheel mechanism is covered on at least a first side of the second frame.

15. A method for operating a gate assembly comprising a first gate portion and a second gate portion, the first gate portion including a first frame and a second frame, and the second gate portion being pivotally coupled to the first frame and comprising a locking mechanism, the method comprising:
engaging the locking mechanism to change a lock state of the locking mechanism from a locked state to an unlocked state;
pivoting the second gate portion about a horizontal axis from a first position to a second position; and
pivoting the first frame and the second gate portion about a vertical axis to open a gate opening in the second frame.

16. The method of claim 15, wherein in the first position the second gate portion is arranged at an angle less than 90 degrees above horizontal.

17. The method of claim 16, wherein the angle is between 25 degrees and 65 degrees above horizontal.

18. The method of claim 15, wherein pivoting the second gate portion about a horizontal axis from the first position to the second position enables pivoting the first frame and the second gate portion about a vertical axis to open a gate opening in the second frame.

19. The method of claim 15, wherein the locking mechanism includes a button and engaging the locking mechanism includes compressing the button.

20. The method of claim 15, further comprising:
pivoting the first frame and the second gate portion about the vertical axis to close the gate opening; and
pivoting the second gate portion about the horizontal axis from the second position to the first position.
